(19) United States
(12) Patent Application Publication
(10) Pub. No.: US 2005/0231772 A1
(43) Pub. Date: Oct. 20, 2005

(54) Image forming apparatus

(75) Inventors: Yoshitaka Kitaoka, Osaka (JP); Noriyuki Tajima, Osaka (JP); Atsushi Sogami, Sanda-shi (JP); Hiroshi Terada, Ikoma-shi (JP); Yuzo Kawano, Ogori-shi (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/100,421

(22) Filed: Apr. 7, 2005

(30) Foreign Application Priority Data
Apr. 20, 2004 (JP) 2004-124749

(51) Int. Cl. H04N 1/04

(52) U.S. Cl. 358/498

(57) ABSTRACT

An image forming apparatus that enables a source document ejected after image information reading is completed, and a printed sheet on which an image has been formed based on the image information, to be removed easily with one hand while maintaining their segregated state. In this apparatus, a source document feed tray holds a source document. A source document ejection tray is positioned below source document feed tray, and holds an ejected source document. A sheet ejection tray is positioned above source document feed tray, and holds a printed sheet ejected onto the uppermost part of the main body of the apparatus. Source document ejection rollers eject a source document into source document ejection tray so that the ejection direction downstream edge of source document ejected into source document ejection tray faces the ejection direction downstream-side position of source document ejection tray rather than the source document feeding direction upstream edge of source document feed tray.

### BACKGROUND OF THE INVENTION

1. Field of the Invention

The present invention relates to an image forming apparatus, and more particularly to an image forming apparatus useful for employment in a multifunctional composite machine that integrates a scanner, copier, printer, facsimile, and so forth, incorporating an automatic document feeder (ADF).

2. Description of the Related Art

Conventionally, taking user operability into consideration, in this kind of image forming apparatus a reading section composed of a flatbed scanner that reads source document image information by means of manual user operations is generally positioned on the top of the main body of the apparatus. Also, in this kind of image forming apparatus, an automatic document feeder that automatically feeds a source document and reads image information is positioned above the aforementioned reading section.

Thus, with this kind of image forming apparatus, since the automatic document feeder is positioned at the uppermost part of the main body of the apparatus, a printed sheet on which an image has been formed by the image forming section is ejected onto and placed upon a sheet ejection platform positioned at the side of the main body of the apparatus. As this image forming apparatus is configured so that the image forming section projects from the side of the main body of the apparatus, the required footprint (installation area) is larger than it appears.

Thus, in recent years, an image forming apparatus has been proposed that has a configuration whereby a space is formed in the waist section of the main body of the apparatus between the reading section and image forming section, and a printed sheet ejection section is formed in this space (see, for example, Unexamined Japanese Patent Publication No. 2003-307996). With this image forming apparatus, except for a manual-feed tray that is opened and used in special cases, nothing projects from the side of the main body of the apparatus, enabling the footprint to be kept small.

However, the configuration of this image forming apparatus is such that the ejection section formed in the waist section of the main body of the apparatus is hidden behind an operation panel on the front of the main body of the apparatus, the aforementioned reading section, or the like, making it difficult to view or remove a printed sheet ejected into the ejection section. Also, since a space is formed in the waist section of the main body of the apparatus, a problem with this image forming apparatus is that its housing structure and exterior configuration are complicated, and extra costs are incurred in order to maintain the strength of the main body of the apparatus, and so forth.

Prior to this, the present applicants proposed an image forming apparatus configured so that a printed sheet can be ejected onto the uppermost part of the automatic document feeder (see, for example, Unexamined Japanese Patent Publication No. HEI8-286450).

With this image forming apparatus, since a printed sheet can be ejected onto the uppermost part of the main body of the apparatus, checking and removal of an ejected printed sheet can be carried out easily. Also, since nothing projects from the side of the main body of the apparatus, the footprint of this image forming apparatus can be made smaller.

However, the automatic document feeder of this image forming apparatus also serves as the source document cover of a source document placed on the source document placement platform on the top of the reading section, and is configured so as to open and close freely with respect to the main body of the apparatus. Consequently, with an image forming apparatus having this configuration, when a thick source document such as a book is placed on this source document placement platform on the top of the reading section, misregistration occurs in the ejection path of a printed sheet due to lifting of the source document cover (the lower surface of the automatic document feeder). Therefore, a problem with an image forming apparatus having this kind of configuration is how to eliminate printed sheet jams caused by ejection path misregistration.

Thus, the image forming apparatus described in Unexamined Japanese Patent Publication No. HEI8-286450 is configured so that a printed sheet can be ejected onto the uppermost part even if the source document cover is lifted, by providing the ejection path from the image forming section to the top of the main body of the apparatus in the vicinity of the opening/closing axis of the source document cover.

Incidentally, in recent years, in line with the digitalization of document data and image data, a trend in multifunctional image forming apparatuses used in general offices is a marked increase in the frequency of image forming based on electronic data input from an external source such as a personal computer (PC), facsimile (FAX), or memory card, to the extent that copying of paper documents is performed only occasionally.

Thus, with this kind of image forming apparatus, since there are fewer occasions for performing copying by means of manual user operations, it is not uncommon for a printed sheet on which an image has been formed by means of an instruction from an external source to be left ejected on the sheet ejection platform.

In such a case, with the image forming apparatus described in Unexamined Japanese Patent Publication No. 2003-307996, since the visibility of an ejected printed sheet is poor, there is a risk that an ejected printed sheet will be placed upon a previously ejected printed sheet and become indistinguishable.

Also, with recent image forming apparatuses, it has become possible to copy a source document so faithfully that the copy cannot be distinguished from the original at a glance. Consequently, with an image forming apparatus capable of performing such high-quality image forming, if a printed sheet and the original source document are inadvertently stacked together, it may not be possible to distinguish the copy from the original. It is therefore desirable for this kind of image forming apparatus to be configured so that a source document can be protected more than a printed sheet regardless of the quality.

However, with the image forming apparatus described in Unexamined Japanese Patent Publication No. 2003-307996, since a source document and a printed sheet are ejected into separate areas, it is difficult to place together and simultaneously remove a source document and printed sheet while maintaining their segregated state, and one is forced to remove the source document and printed sheet separately. Consequently, with this image forming apparatus, there is a high risk of the user stacking together a separately removed source document and printed sheet, with the result that it may become impossible to distinguish between the source document and printed sheet.

By contrast, with the image forming apparatus described in Unexamined Japanese Patent Publication No. HEI8-286450, a printed sheet is ejected onto the uppermost part of the main body of the apparatus, so that the user can easily confirm the presence of a printed sheet when performing a copying operation. Therefore, with this image forming apparatus, there is little risk that another printed sheet will be placed upon a previously ejected printed sheet and become indistinguishable.

However, in the image forming apparatus described in Unexamined Japanese Patent Publication No. HEI8-286450, a source document feed platform that holds a source document is positioned below a sheet ejection platform that holds a printed sheet, and furthermore a source document ejection platform that holds a source document that has been read is positioned below the source document feed platform.

Consequently, with this image forming apparatus, a source document and printed sheet have to be removed separately because a source document ejected onto the source document ejection platform is hidden beneath the source document feed platform, and there is a risk of the user stacking together a source document and printed sheet.

Thus, problems relating to convenience remain with this kind of image forming apparatus, such as the difficulty of placing together and simultaneously removing a source document and printed sheet while maintaining their segregated state, and the risk of becoming unable to distinguish between a source document and printed sheet.

### SUMMARY OF THE INVENTION

It is an object of the present invention to provide a highly convenient image forming apparatus that makes it possible for a source document ejected after image information reading is completed, and a printed sheet on which an image has been formed based on the image information, to be removed easily with one hand while maintaining their segregated state.

The present invention achieves the above object by ejecting a source document onto a source document ejection platform so that the ejection direction downstream edge of the source document ejected onto the source document ejection platform faces the ejection direction downstream-side position of the source document ejection platform rather than the source document feeding direction upstream edge of the source document feed platform.

According to an aspect of the invention, there is an image forming apparatus, comprising: a source document feed platform for holding a source document that is fed automatically; a source document ejection platform for holding a source document fed from the aforementioned source document feed platform and ejected, positioned below the aforementioned source document feed platform; a sheet ejection platform for holding a printed sheet on which an image of the aforementioned source document has been formed and that is ejected onto the uppermost part of the main body of the apparatus, positioned above the aforementioned source document feed platform; and a source document ejection section that ejects a source document on to the aforementioned source document ejection platform so that the ejection direction downstream edge of the source document ejected onto the aforementioned source document ejection platform faces the ejection direction downstream-side position of the aforementioned source document ejection platform rather than the source document feeding direction upstream edge of the aforementioned source document feed platform.

According to another aspect of the invention, there is an image forming apparatus, comprising: a source document feed platform for holding a source document; a source document ejection platform for holding a source document fed from the aforementioned source document feed platform and ejected, positioned above the aforementioned source document feed platform; and a sheet ejection platform for holding a printed sheet on which an image of the aforementioned source document has been formed and that is ejected onto the uppermost part of the main body of the apparatus, positioned above the aforementioned source document ejection platform; wherein a source document placed on the aforementioned source document ejection platform and the aforementioned printed sheet placed on the aforementioned sheet ejection platform are ejected so that their respective front and rear sides are opposite.

According to still another aspect of the invention, there is an automatic document feeder positioned on the top part of the main body of an image forming apparatus provided with an image forming section that performs image forming on a sheet based on source document image information, comprising: a source document feed platform for holding the aforementioned source document; a source document feeding section that feeds the aforementioned source document placed on the aforementioned source document feed platform; a source document reading section that reads image information of the aforementioned source document fed by the aforementioned source document feeding section; a source document ejection section that ejects the aforementioned source document from which the aforementioned image information has been read by the aforementioned source document reading section; a source document ejection platform for holding the aforementioned source document ejected by the aforementioned source document ejection section, positioned below the aforementioned source document feed platform; a sheet ejection section that transports to above the aforementioned source document feed platform and ejects a printed sheet on which image forming has been performed by the aforementioned image forming section; and a sheet ejection platform for holding the aforementioned printed sheet ejected by the aforementioned sheet ejection section, positioned above the aforementioned source document feed platform; wherein the aforementioned source document ejection section ejects a source document onto the aforementioned source document ejection platform so that the ejection direction downstream edge of the source document ejected onto the aforementioned source document ejection platform faces the ejection direction downstream-side position of the aforementioned source document ejection platform rather than the source document feeding direction upstream edge of the aforementioned source document feed platform.

According to a further aspect of the invention, there is an automatic document feeder positioned on the top part of the main body of an image forming apparatus provided with an image forming section that performs image forming on a sheet based on source document image information, comprising: a source document feed platform for holding the aforementioned source document; a source document feeding section that feeds the aforementioned source document placed on the aforementioned source document feed platform; a source document reading section that reads image information of the aforementioned source document fed by the aforementioned source document feeding section; a source document reverse ejection section that takes the aforementioned source document from which the aforementioned image information has been read by the aforementioned source document reading section as a source document and ejects that source document with the front and rear sides reversed; a source document ejection platform for holding the aforementioned source document ejected by the aforementioned source document reverse ejection section, positioned above the aforementioned source document feed platform; a sheet ejection section that transports to above the aforementioned source document feed platform and ejects a printed sheet on which image forming has been performed by the aforementioned image forming section; and a sheet ejection platform for holding the aforementioned printed sheet ejected by the aforementioned sheet ejection section, positioned above the aforementioned source document feed platform.

According to a still further aspect of the invention, there is an image forming apparatus, comprising: a source document feed platform for holding a source document that is fed automatically; a source document ejection platform for holding a source document fed from the aforementioned source document feed platform and ejected, positioned below the aforementioned source document feed platform; a sheet ejection platform for holding a printed sheet on which an image of the aforementioned source document has been formed and that is ejected onto the uppermost part of the main body of the apparatus, positioned above the aforementioned source document feed platform; and a source document ejection section that ejects the aforementioned source document onto the aforementioned source document ejection platform; wherein cutaway sections of the aforementioned source document feed platform and the aforementioned sheet ejection platform are provided at positions vertically opposite part of the peripheral part of a source document placed on the aforementioned source document ejection platform.

According to a yet further aspect of the invention, there is an image forming apparatus, comprising: a source document feed platform for holding a source document that is fed automatically;
a source document ejection platform for holding a source document ejected from said source document feed platform; and
a sheet ejection platform for holding a printed sheet on which an image of said source document has been formed, said source document feed platform, source document ejection platform and sheet ejection platform being provided along a vertical line,
wherein an interval between the source document ejection platform and the sheet ejection platform is set in a dimension that enables a user to use one hand and hold the source document placed in the source document ejection platform and the printed sheet placed in the sheet ejection platform together between fingers of said one hand; and
wherein cutaway sections are provided in mutually vertically opposite areas in the source document ejection platform and the sheet ejection platform to allow entry of the fingers of the user, so as to enable the user to use one hand and hold the source document placed in the source document ejection platform and the printed sheet placed in the sheet ejection platform in a state in which the two documents overlie upon one another in said one hand of the user.

### BRIEF DESCRIPTION OF THE DRAWINGS

The above and other objects and features of the invention will appear more fully hereinafter from a consideration of the following description taken in conjunction with the accompanying drawing, in which:

FIG. 1 is a schematic oblique drawing showing an external view of an image forming apparatus according to Embodiment 1 of the present invention;

FIG. 2 is a schematic cross-sectional drawing showing the overall configuration of an image forming apparatus according to Embodiment 1 of the present invention;

FIG. 3 is a schematic cross-sectional drawing showing the operating situation in the automatic copying mode of an image forming apparatus according to Embodiment 1 of the present invention;

FIG. 4 is a schematic cross-sectional drawing showing the situation at the end of copying of an image forming apparatus according to Embodiment 1 of the present invention;

FIG. 5 is a schematic oblique drawing showing an external view of an image forming apparatus according to Embodiment 2 of the present invention;

FIG. 6 is a schematic cross-sectional drawing showing the overall configuration of an image forming apparatus according to Embodiment 3 of the present invention;

FIG. 7 is a schematic oblique drawing showing an external view of an image forming apparatus according to Embodiment 4 of the present invention;

FIG. 8 is a schematic cross-sectional drawing showing the overall configuration of an image forming apparatus according to Embodiment 4 of the present invention;

FIG. 9 is a schematic cross-sectional drawing showing the operating situation in the automatic copying mode of an image forming apparatus according to Embodiment 4 of the present invention;

FIG. 10 is a schematic cross-sectional drawing showing the situation at the end of copying of an image forming apparatus according to Embodiment 4 of the present invention;

FIG. 11 is a schematic cross-sectional drawing showing the overall configuration of an image forming apparatus according to Embodiment 5 of the present invention;

FIG. 12 is a schematic cross-sectional drawing showing the situation at the end of copying of an image forming apparatus according to Embodiment 5 of the present invention; and

FIG. 13 is a schematic oblique drawing showing an external view of an image forming apparatus according to Embodiment 6 of the present invention.

### DESCRIPTION OF THE PREFERRED EMBODIMENTS

With reference now to the accompanying drawings, embodiments of the present invention will be explained in detail below.

In the drawings, configuration elements and equivalent parts that have identical configurations or function are assigned the same codes, and descriptions thereof are not repeated.

### Embodiment 1

First, an image forming apparatus according to Embodiment 1 of the present invention will be described.

An image forming apparatus according to Embodiment 1 has a configuration as a multifunctional composite machine having a copying function that copies paper documents, book source documents, and so forth, a print function that prints out electronic data and so forth transmitted from a PC or the like, a facsimile function that transmits and receives to/from a FAX or the like, and so forth. It goes without saying that the present invention can also be applied to an image forming apparatus provided with only a single function.

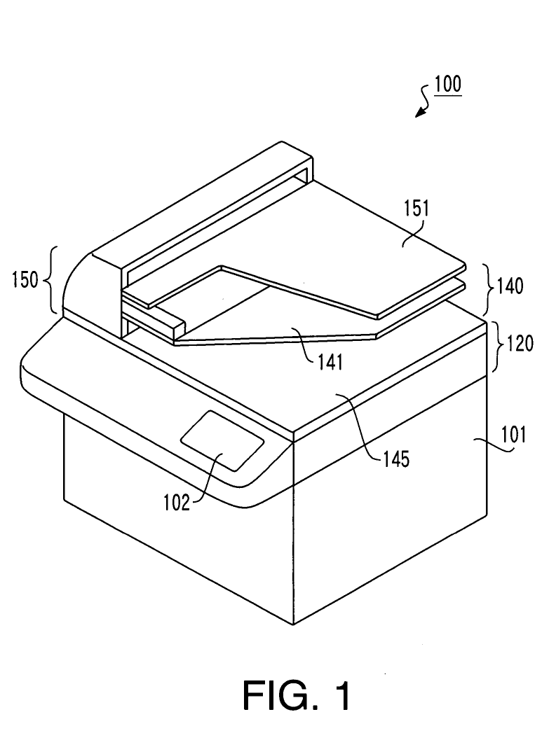

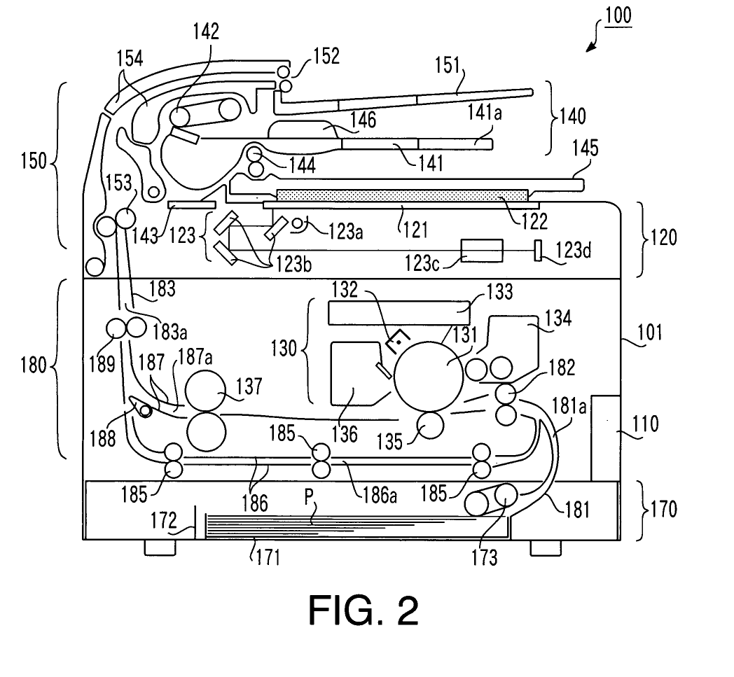

FIG. 1 is a schematic oblique drawing showing an external view of an image forming apparatus according to Embodiment 1 of the present invention, and FIG. 2 is a schematic cross-sectional drawing showing the overall configuration of an image forming apparatus according to Embodiment 1 of the present invention.

As shown in FIG. 2, this image forming apparatus 100 includes a receiving section 110, a reading section 120, an image forming section 130, an automatic document feeder 140, a sheet ejection section 150, a feeding section 170, a transporting system 180, and so forth.

Receiving section 110 receives image information input from an external device such as a PC, FAX, or storage medium (memory card) via a LAN (including a wireless LAN) or public circuit. Image forming apparatus 100 is equipped with a LAN port to which a LAN cable is connected, a modular connector to which a public circuit is connected, a card slot into which a memory card is inserted, and so forth (none of which is shown in the figure).

As shown in FIG. 1, reading section 120 is positioned on top of the main body of the apparatus 101. As shown in FIG. 2, reading section 120 of this example is composed of a source document holding platform (contact glass) 121 on which a sheet source document or book source document to be copied is placed manually by the user, a source document cover 122 that covers a sheet source document (or book source document) placed on source document holding platform 121, a scanning optical system 123 that scans a sheet source document (or book source document) image and reads image information, and so forth.

Scanning optical system 123 of this example is composed of a light source 123a, mirrors 123b, a lens 123c, an image pickup device (CCD) 123d, and so forth. Source document cover 122 has a configuration combining a source document ejection tray 145 as the source document ejection platform of automatic document feeder 140 described later herein.

Image forming section 130 is positioned approximately in the center of main body 101 of image forming apparatus 100. Image forming section 130 of this example is composed of a photosensitive body 131, an electrifier 132, an exposure apparatus 133, a developing apparatus 134, a transfer roller 135, a cleaning apparatus 136, a fixing apparatus 137, and so forth.

As shown in FIG. 1, automatic document feeder 140 is positioned on top of reading section 120. As shown in FIG. 2, automatic document feeder 140 of this example is equipped with a source document feed tray 141 as a source document feed platform, source document feed rollers 142 as a source document feeding section, a scanner 143 as a source document reading section, source document ejection rollers 144 as a source document ejection section, a source document ejection tray 145 as a source document ejection platform, and so forth.

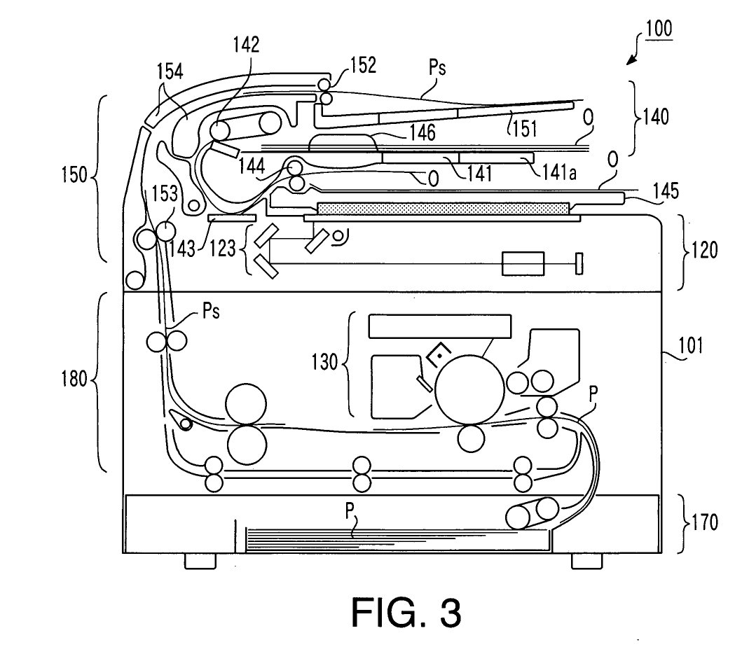

Source document feed tray 141 holds source documents 0 to be fed automatically (see FIG. 3). Attached to this source document feed tray 141 is a source document position regulating plate 146 that determines the side position of stacked source documents O.

Source document feed rollers 142 separate source documents O placed (set) in source document feed tray 141 one at a time and feed each source document toward scanner 143. Scanner 143 reads image information of a source document O separated and fed by means of source document feed rollers 142.

Source document ejection rollers 144 eject source document O for which image information reading by scanner 143 has been completed onto source document ejection tray 145.

Automatic document feeder 140 of this example is configured so that one sheet at a time of source documents O placed (set) in source document feed tray 141 is separated and fed by means of source document feed rollers 142, and is ejected by means of source document ejection rollers 144 onto source document ejection tray 145 positioned below source document feed tray 141. Also, automatic document feeder 140 of this example is configured so as to open and close freely with respect to main body 101 together with source document cover 122.

Sheet ejection section 150 is equipped with a sheet ejection tray 151 as a sheet ejection platform, sheet ejection rollers 152 as a sheet ejection section, sheet transport rollers 153, sheet ejection guide plates 154, and so forth. As shown in FIG. 3, this sheet ejection section 150 is configured so that a printed sheet Ps on which an image has been formed by image forming section 130 described later herein is ejected onto the uppermost part of main body 101.

In FIG. 1 through FIG. 3, sheet ejection tray 151 is positioned atop source document feed tray 141, and holds a printed sheet Ps ejected from the machine.

Sheet ejection rollers 152 eject printed sheet Ps onto sheet ejection tray 151. Sheet transport rollers 153 transport printed sheet Ps toward sheet ejection rollers 152. Sheet ejection guide plates 154 guide printed sheet Ps transported toward sheet ejection rollers 152 by sheet transport rollers 153. Sheet ejection section 150 is structurally integral with automatic document feeder 140.

As shown in FIG. 2, feeding section 170 is composed of a cassette housing section 172 for holding a paper feed cassette 171 containing sheets P as a recording medium such as copy paper or OHP sheets, a separating and feeding apparatus 173 that separates and feeds individual sheets P held in paper feed cassette 171, and so forth.

As shown in FIG. 2, transporting system 180 is equipped with feed guide plates 181 that guide a sheet P from feeding section 170 toward image forming section 130. A feed path 181a is formed by these feed guide plates 181. At the exit of this feed path 181a are positioned registration rollers 182 that transport a sheet P to image forming section 130 at predetermined timing.

Transporting system 180 is also equipped with sheet ejection guide plates 183 that guide a sheet P fixed by fixing apparatus 137 of image forming section 130 toward sheet ejection section 150 at the uppermost part of main body 101. A sheet ejection path 183a is formed by these sheet ejection guide plates 183.

Transporting system 180 of this example also has reverse transport rollers 185 that transport a printed sheet Ps to feed path 181a with its image formation surface reversed, and a reverse transport path 186a formed by reverse transport guide plates 186.

At the confluence of this reverse transport path 186a and an ejection transport path 187a of a sheet P ejected from fixing apparatus 137 of image forming section 130 is positioned a reverse switching lug 188 that switches the transport path of a sheet P that has temporarily left ejection transport path 187a toward reverse transport path 186a. Downstream of reverse switching lug 188 in the ejection direction are positioned forward/reverse rollers 189 that transport sheet P in the topside ejection direction or reverse transportation direction.

Next, the operation of an image forming apparatus according to Embodiment 1 will be described.

This image forming apparatus 100 has three modes: a manual copying mode, an external input print mode, and an automatic copying mode.

Manual copying mode is a print mode in which a sheet source document or book source document placed on source document holding platform 121 manually is copied by means of image information read by CCD 123d of reading section 120.

External input print mode is a print mode in which printout is performed by means of image information from an external device such as a PC, FAX, or memory card, input to receiving section 110.

Automatic copying mode is a print mode in which a document O set on source document feed tray 141 is copied by means of image information read by scanner 143 of automatic document feeder 140.

In manual copying mode, in FIG. 2 source document cover 122 of reading section 120 is opened together with automatic document feeder 140, exposing source document holding platform 121. Then the user manually places a sheet source document or book source document on this exposed source document holding platform 121.

Reading section 120 has a source document size sensor (not shown) as a manual source document detection device that detects the presence of a sheet source document or book source document placed on source document holding platform 121.

In FIG. 2, when the user presses the Copy button on an operation panel 102 of the main body of the apparatus (see FIG. 1) while it is detected by the aforementioned source document size sensor that a sheet source document or book source document has been placed on source document holding platform 121, scanning optical system 123 operates and CCD 123d reads the sheet source document or book source document. Image data read by this CCD 123d is converted to print data by an image processing apparatus (not shown), and then input to exposure apparatus 133 at predetermined timing.

Meanwhile, as a result of pressing the aforementioned Copy button, photosensitive body 131 rotates in the predetermined direction, and the surface of photosensitive body 131 is charged uniformly by electrifier 132. Exposure apparatus 133 irradiates the surface of this uniformly charged photosensitive body 131 with print data converted by the aforementioned image processing apparatus as a laser beam. By means of this laser irradiation, an electrostatic latent image of the read source document is formed on the surface of photosensitive body 131.

This electrostatic latent image is made into a visible image (a toner image) by means of toner supplied from developing apparatus 134. This toner image is then transferred by transfer roller 135 to a sheet P fed at predetermined timing by registration rollers 182, and then fixed onto sheet P by fixing apparatus 137.

A printed sheet Ps on which the image of a sheet source document or book source document has been formed in this way passes along sheet ejection path 183a and is ejected and placed onto sheet ejection tray 151 of sheet ejection section 150.

In aforementioned external input print mode, image information (image data) input to receiving section 110 from an external device such as a PC, FAX, or memory card is stored (accumulated) in memory functioning as a storage device located in main body 101. Image data stored in this memory is converted to print data by an image processing apparatus (not shown) and input to exposure apparatus 133 at predetermined timing.

Also, in this external input print mode, a printed sheet Ps fixed by fixing apparatus 137 is transported toward sheet ejection section 150 via sheet ejection path 183a, and is ejected and placed onto sheet ejection tray 151 by sheet ejection rollers 152.

In aforementioned automatic copying mode, source documents O to be fed automatically are set on source document feed tray 141 of automatic document feeder 140 as shown in FIG. 3. By this means, a source document sensor (not shown) functioning as a source document detection device that detects the presence of a source document O to be fed by automatic document feeder 140 is turned on. When this source document sensor is turned on, preparation for light emission by the lamp of scanner 143 that reads source document O image information, and so forth, is performed.

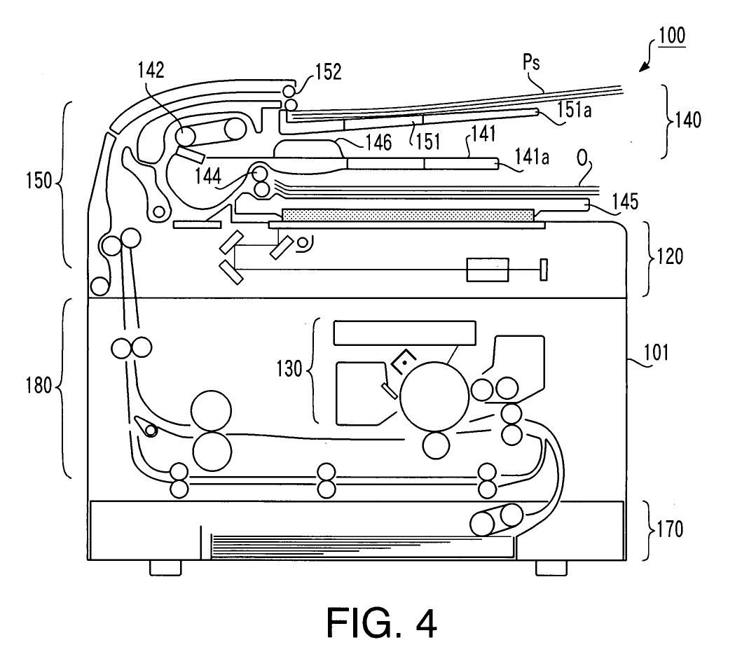

When the user presses the Copy button on operation panel 102 of main body 101 while the source document sensor is on, a source document O on source document feed tray 141 is fed by source document feed rollers 142 as shown in FIG. 3. By this means, source document O is transported while being held in close contact with the source document reading glass of scanner 143, and source document O image information is read. When source document O has been read, it is ejected onto source document ejection tray 145 of automatic document feeder 140 by source document ejection rollers 144 as shown in FIG. 4.

Image information (image data) of a source document O read by scanner 143 of automatic document feeder 140 in this way is stored in the aforementioned memory in the same way as in above-described external input print mode. Image data stored in this memory is converted to print data by an image processing apparatus (not shown) and input to exposure apparatus 133 at predetermined timing.

As in above-described manual copying mode, the surface of uniformly charged photosensitive body 131 is irradiated with this print data input to exposure apparatus 133 at predetermined timing, and the print data is fixed on a sheet P as a toner image by fixing apparatus 137.

A printed sheet Ps on which an image has been formed in this automatic copying mode is transported toward sheet ejection section 150 via sheet ejection path 183a in the same way as in above-described external input print mode. Furthermore, this printed sheet Ps is transported along sheet ejection guide plates 154 by sheet transport rollers 153 and, as shown in FIG. 4, is ejected and placed onto sheet ejection tray 151 positioned above source document feed tray 141 by sheet ejection rollers 152.

Incidentally, in image forming apparatus 100 according to Embodiment 1, source document ejection rollers 144 are positioned downstream of source document feed rollers 142 in the source document ejection direction, and the ejection direction downstream edge of a source document O that has been read faces a position (on the right in FIG. 4) skipping further downstream in the ejection direction than source document feeding direction upstream edge 141a of source document feed tray 141.

Also, in this image forming apparatus 100, sheet ejection rollers 152 are positioned downstream of source document ejection rollers 144 in the ejection direction, and the ejection direction downstream edge of a printed sheet Ps faces a position further downstream in the ejection direction than sheet ejection direction downstream-side edge 151a of sheet ejection tray 151—more exactly, a position (on the right in FIG. 4) skipping downstream in the ejection direction.

Therefore, in this image forming apparatus 100, when image forming is performed using automatic document feeder 140, the ejection direction downstream edges of a source document O that has been read and a printed sheet Ps are ejected at mutually separated positions. Also, as shown in FIG. 4, source document feeding direction upstream edge 141a of source document feed tray 141 is positioned more inwardly than the ejection direction downstream edges of both a read source document O and a printed sheet Ps.

By this means, with this image forming apparatus 100, a user can insert a hand beneath a source document O ejected onto source document ejection tray 145, simultaneously grasp a read source document O and printed sheet Ps with one hand in that state, and remove them easily.

Also, with this image forming apparatus 100, when a read source document O and printed sheet Ps are grasped simultaneously, their ejection direction downstream edges are mutually displaced, so that they can easily be differentiated even though they are removed as they are in overlapping fashion.

### Embodiment 2

Next, an image forming apparatus according to Embodiment 2 of the present invention will be described.

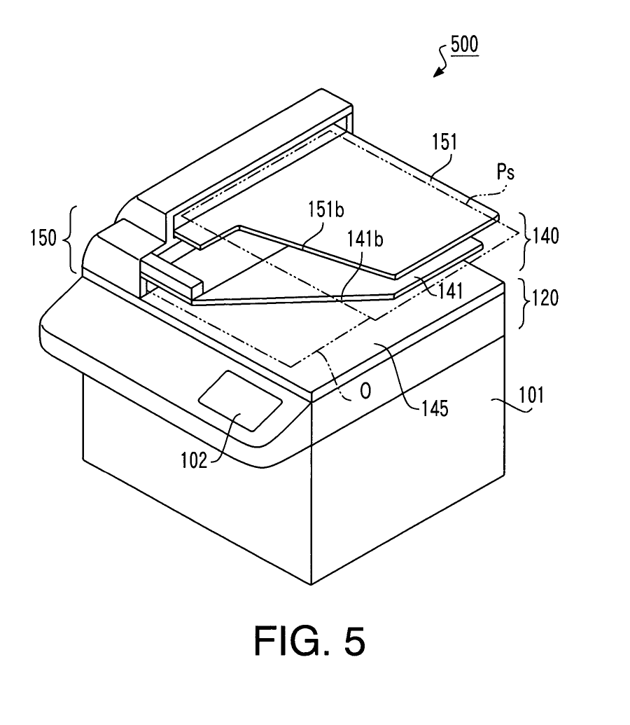

FIG. 5 is a schematic oblique drawing showing an external view of an image forming apparatus according to Embodiment 2 of the present invention.

As shown in FIG. 5, in this image forming apparatus 500, a printed sheet Ps placed in sheet ejection tray 151 and a source document O placed in source document ejection tray 145 are ejected so as to be mutually positionally displaced in a direction orthogonal to the ejection direction. That is to say, this image forming apparatus 500 is configured so that the center of the source document O ejection path and the center of the printed sheet Ps ejection path are in mutually displaced positions.

With this image forming apparatus 500, a user can simultaneously grasp a read source document O and a printed sheet Ps with one hand, and remove them while maintaining a positional relationship in which there is mutual positional displacement in ejection directions, as a result of which convenience is further improved.

Also, with this image forming apparatus 500, the positional relationship between source document ejection tray 145 and sheet ejection tray 151 can also be configured as a positional relationship whereby there is mutual positional displacement in a direction orthogonal to the ejection direction, so that an operation to set a source document O in source document ejection tray 145 positioned below sheet ejection tray 151 can be performed easily.

Furthermore, as shown in FIG. 5, cutaway sections 141b and 151b of source document feed tray 141 and sheet ejection tray 151 are provided at positions vertically opposite the ejection direction downstream edge of a source document O placed on source document ejection tray 145 after reading is completed. That is to say, cutaway sections 141b and 151b opening in a vertical direction are provided respectively in source document feed tray 141 and sheet ejection tray 151 positioned above source document ejection tray 145 so as to overlap in a vertical direction with respect to source document ejection tray 145.

More specifically, cutaway section 151b of sheet ejection tray 151 is formed by cutting-away of sheet ejection tray 151, including one ejection direction downstream-side edge, into a trapezoidal shape. As a result, sheet ejection tray 151 itself, in a plan view, has a shape having a trapezoidal part that includes one side section inclined toward the ejection direction downstream side.

Also, cutaway section 141b of source document feed tray 141 is formed by cutting away slantwise one source document feed direction upstream-side edge of source document feed tray 141.

The above-described cutaway areas in sheet ejection tray 151 and source document feed tray 141 are mutually opposite areas on source document ejection tray 145. The configuration is such that a part of source document ejection tray 145—here, one ejection direction downstream-side edge—is exposed upward in image forming apparatus 500 via these cutaway sections 141b and 151b. One ejection direction downstream edge of a read source document O ejected from source document ejection roller 144 is positioned on one ejection direction downstream edge.

As a result, the ejection direction downstream edges of a source document O and printed sheet Ps are placed so as to jut out from cutaway sections 141b and 151b of source document feed tray 141 and sheet ejection tray 151 respectively. That is to say, the ejection direction downstream edges of an ejected source document O and printed sheet Ps respectively are positioned so as to be mutually opposite via cutaway sections 141b and 151b.

In other words, sheet ejection tray 151 and source document feed tray 141 are configured so that a part of the peripheral part of a printed sheet Ps placed on sheet ejection tray 151 faces a part of the peripheral part of a source document placed on source document ejection tray 145. That is to say, parts of the outer-edge parts of sheet ejection tray 151 and source document feed tray 141 are positioned further inward than the outer edge of the placement area of a read source document placed on source document ejection tray 145, above source document ejection tray 145. As a result, a part of a printed sheet Ps is placed so as to jut out from part of the outer-edge part of sheet ejection tray 151, and is opposite a part of a source document O ejected and placed onto source document ejection tray 145.

Also, source document ejection tray 145 is positioned below—here, directly beneath—source document feed tray 141, and sheet ejection tray 151 is positioned above—here, directly above—source document feed tray 141. Consequently, a source document on source document feed tray 141 and a printed sheet Ps on sheet ejection tray 151 are placed in adjacent positions—that is, in positions in which the user can simultaneously grasp a read source document O and a printed sheet Ps with one hand.

Therefore, with image forming apparatus 500, source document feed tray 141 and sheet ejection tray 151 do not cause an obstruction when the ejection direction downstream edges of a source document O and printed sheet Ps jutting out from cutaway sections 141b and 151b are simultaneously grasped with one hand. Thus a user can insert a hand beneath a source document O ejected onto source document ejection tray 145, and directly and easily grasp source document O and printed sheet Ps simultaneously with one hand.

Cutaway section 151b may be of any shape, as long a part of source document ejection tray 145—here, a part that faces the ejection direction downstream edge—is cut away, and as long as cutaway section 151b allows entry of fingers of one hand of the user, together with cutaway section 141b.

For example, cutaway section 151b may be formed by cutting away slantwise an ejection direction downstream-side edge of sheet ejection tray 151, in the same way as with cutaway section 141b of this embodiment.

Other configuration elements and operations in image forming apparatus 500 of this example are similar to configuration elements and operations of image forming apparatus 100 according to Embodiment 1, and therefore descriptions thereof are omitted here.

### Embodiment 3

Next, an image forming apparatus according to Embodiment 3 of the present invention will be described.

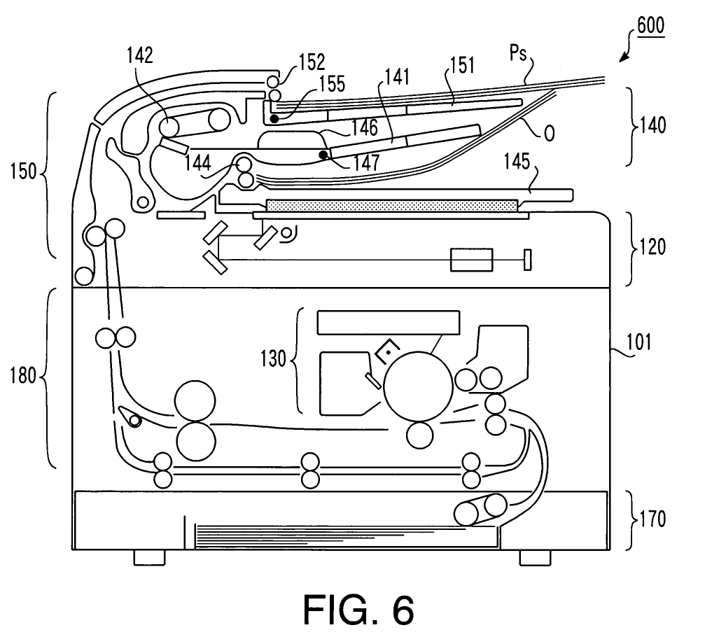

FIG. 6 is a schematic cross-sectional drawing showing the overall configuration of an image forming apparatus according to Embodiment 3 of the present invention.

As shown in FIG. 6, this image forming apparatus 600 is configured so that the base of source document feed tray 141 is pivoted so as to swing freely on a spindle 147 attached to the main body of automatic document feeder 140, and in FIG. 6, source document feed tray 141 is displaced upward.

With this image forming apparatus 600, when a user inserts a hand beneath a source document O ejected onto source document ejection tray 145, and simultaneously grasps a read source document O and printed sheet Ps with one hand in that state, source document feed tray 141 is displaced upward as shown in FIG. 6.

Therefore, with this image forming apparatus 600, a user can easily perform the task of simultaneously grasping and removing with one hand a read source document O and a printed sheet Ps.

Also, with this image forming apparatus 600, when a user grasps and lifts a read source document O and printed sheet Ps, their ejection direction downstream edges are mutually positionally displaced, as shown in FIG. 6, so that they can surely and easily be differentiated even though they are removed as they are in overlapping fashion.

Also, this image forming apparatus 600 is configured so that the base of sheet ejection tray 151 is pivoted so as to swing freely on a spindle 155 attached to the main body of automatic document feeder 140, and in FIG. 6, sheet ejection tray 151 is displaced upward.

With this image forming apparatus 600, when a source document O is set on source document feed tray 141, sheet ejection tray 151 is displaced upward and source document feed tray 141 can be greatly exposed, enabling the task of setting a source document O in source document feed tray 141 to be performed more easily.

Other configuration elements and operations in image forming apparatus 600 of this example are similar to configuration elements and operations of image forming apparatus 100 according to Embodiment 1, and therefore descriptions thereof are omitted here.

### Embodiment 4

Next, an image forming apparatus according to Embodiment 4 of the present invention will be described.

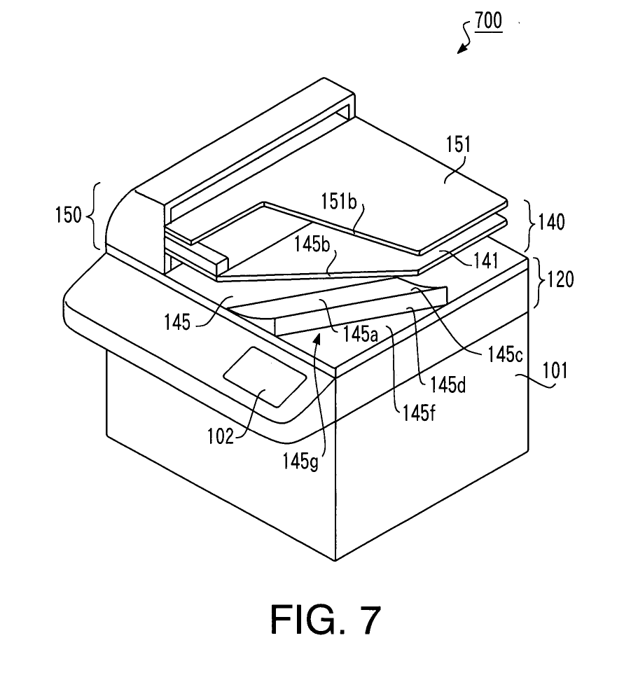

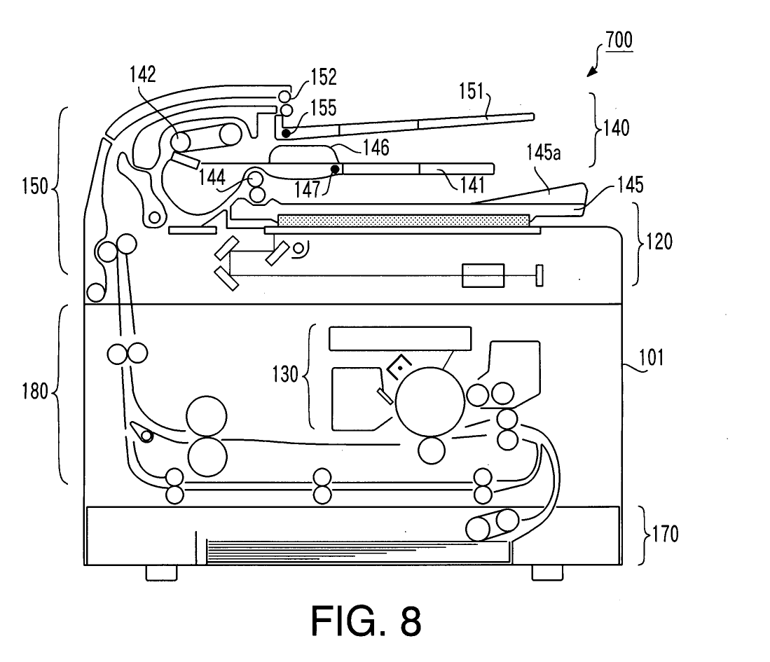

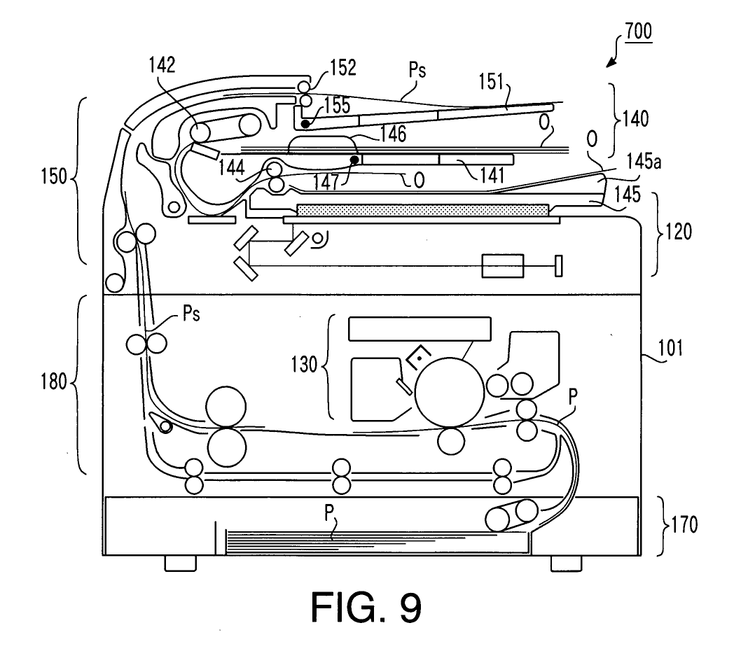

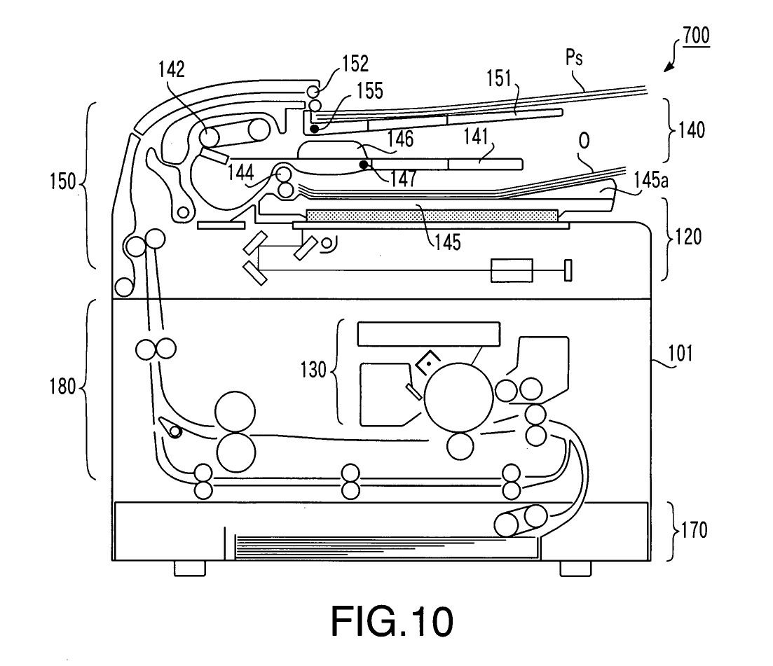

FIG. 7 is a schematic oblique drawing showing an external view of an image forming apparatus according to Embodiment 4 of the present invention. FIG. 8 is a schematic cross-sectional drawing showing the overall configuration of an image forming apparatus according to Embodiment 4 of the present invention. FIG. 9 is a schematic cross-sectional drawing showing the operating situation in the automatic copying mode of an image forming apparatus according to Embodiment 4 of the present invention. FIG. 10 is a schematic cross-sectional drawing showing the situation at the end of copying of an image forming apparatus according to Embodiment 4 of the present invention.

Image forming apparatus 700 shown in FIG. 7-10 has source document feed tray 141 that holds a source document that is fed automatically, source document ejection tray 145 that holds a source document ejected from source document feed tray 141, and sheet ejection tray 151 that holds a printed sheet on which an image of the source document has been formed, and these trays are lined in a vertical direction.

As shown in FIG. 7 and FIG. 8, this image forming apparatus 700 has a curved section 145a on source document ejection tray 145. As shown in FIG. 9 and FIG. 10, this curved section 145a is configured so that the ejection direction downstream edge of a source document O ejected into source document ejection tray 145 is made to curve upward.

To be more specific, the curved section 145a has a curved portion 145c that rises upward in the ejection direction on the top of the main body of the document ejection tray 145 and a vertical portion 145d that rises vertically from the top of the main body of the document ejection tray 145 and merges with the upper end of the curved portion 145c. Having this curved portion 145a, the document ejection tray 145 forms a cutaway section 145g between the vertical portion 145d on the document ejection tray 145 and an upper portion 145f of the main body of the document ejection tray 145 further downstream in the ejection direction so as to allow entry of fingers of one hand of a user.

In this image forming apparatus 700, the ejection direction downstream edge of a source document O ejected and placed into source document ejection tray 145 is curved upward by curved section 145a. By this means, the clearance of the ejection direction downstream edges of both a source document O and printed sheet Ps can be reduced to a distance that enables a user easily to grasp source document O and printed sheet Ps simultaneously with one hand.

The interval between document ejection tray 145 and sheet ejection tray 151 is set in a dimension that enables a user to use one hand and hold both a source document O placed in source document ejection tray 145 and a printed sheet Ps placed in sheet ejection tray 151 together between fingers.

Also, this image forming apparatus 700 is equipped with cutaway sections 141b and 151b of source document feed tray 141 and sheet ejection tray 151 at positions vertically opposite curved section 145a of source document ejection tray 145 (see FIG. 7).

Here, as shown in FIG. 7, cutaway section 151b of sheet ejection tray 151 is cut away substantially in excess of the range of movement of freely displaceable source document position regulating plate 146 that determines the side position of a source document O placed in source document feed tray 141. By this means, the ejection direction downstream edges of a source document O and a printed sheet Ps are placed so as to jut out from cutaway sections 141b and 151b of source document feed tray 141 and sheet ejection tray 151 respectively.

Therefore, with image forming apparatus 700, when the ejection direction downstream edges of a source document O and printed sheet Ps jutting out from cutaway sections 141b and 151b are simultaneously grasped with one hand, source document feed tray 141 and sheet ejection tray 151 do not cause an obstruction, and a user can insert a hand beneath a source document O ejected onto source document ejection tray 145, and directly and easily grasp source document O and printed sheet Ps simultaneously with one hand.

In this image forming apparatus 700, cutaway sections 145g and 151b are provided in vertically opposite areas in source document ejection tray 145 and sheet ejection tray 151 so as to allow entry of fingers of one hand of the user.

In addition, in source document feed tray 141, cutaway section 141a is provided in a vertically opposite area in relation to cutaway section 145g and 151b so as to allow entry of fingers of one hand of the user.

To be more specific, according to the above configuration with cutaway sections 145g, 151b and 141, the user can remove the both documents, the source document O placed in source document ejection tray 145 and the printed sheet Ps placed in sheet ejection tray 151, laid over one another in one hand.

Other configuration elements and operations in image forming apparatus 700 of this example are similar to configuration elements and operations of image forming apparatus 600 according to Embodiment 3, and therefore descriptions thereof are omitted here.

Cutaway section 151b may be of any shape, as long a part of source document ejection tray 145—here, a part that faces the ejection direction downstream edge—is cut away, and as long as cutaway section 151b allows entry of the fingers of one hand of the user, together with cutaway section 141b.

For example, cutaway section 151b may be formed by cutting away slantwise an ejection direction downstream-side edge of sheet ejection tray 151, in the same way as with cutaway section 141b of this embodiment.

In addition, cutaway section 145g may be formed by cutting away slantwise a part of the ejection direction downstream-side edge of source document ejection tray 145, as long as cut away section 145g allows entry of fingers of one hand of the user.

Moreover, cutaway sections 141b and 151b may be formed by two adjoining planes on the tray in which the cutaways section 141b or cutaway section 151b is provided.

### Embodiment 5

Next, an image forming apparatus according to Embodiment 5 of the present invention will be described.

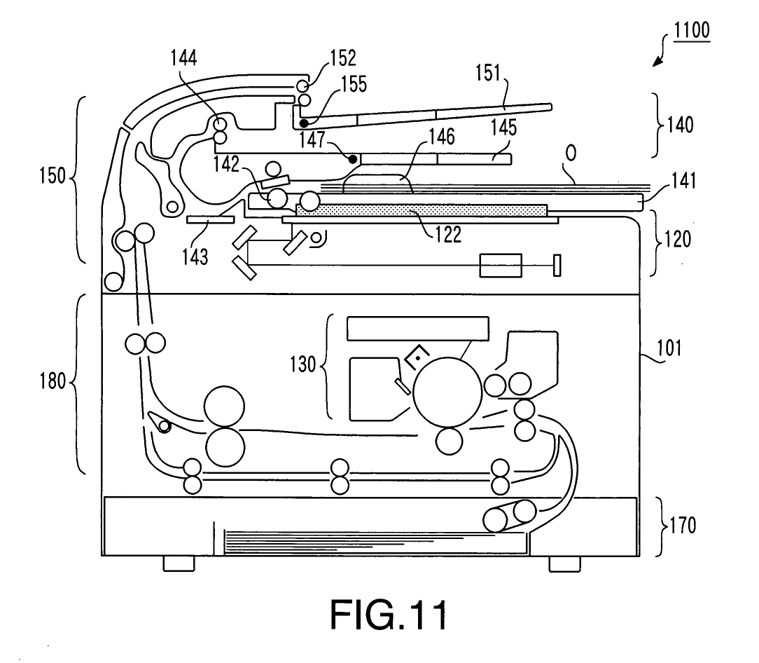

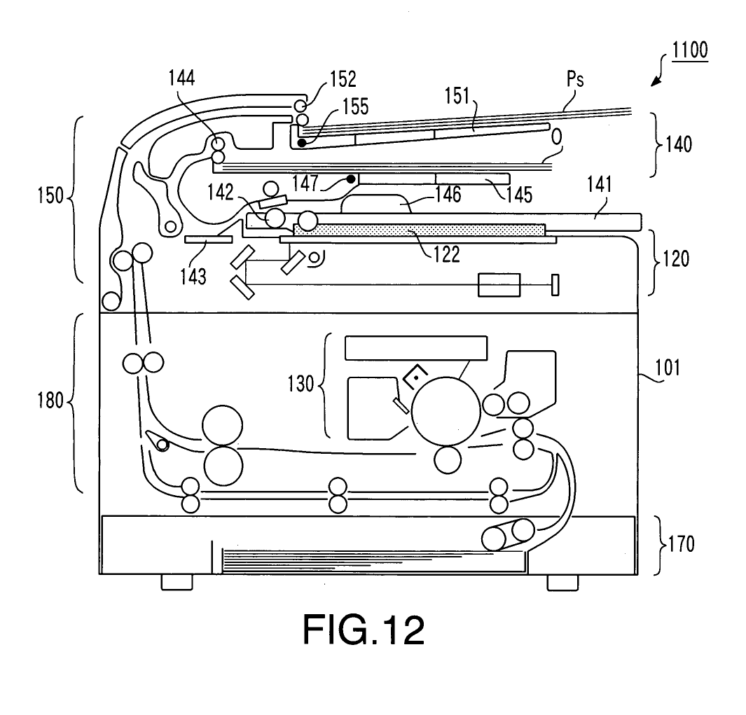

FIG. 11 is a schematic cross-sectional drawing showing the overall configuration of an image forming apparatus according to Embodiment 5 of the present invention, and FIG. 12 is a schematic cross-sectional drawing showing the situation at the end of copying of an image forming apparatus according to Embodiment 5 of the present invention.

An image forming apparatus 1100 according to Embodiment 5 is configured so that a source document O placed on source document feed tray 141 and a printed sheet Ps placed on sheet ejection tray 151 are ejected so that their respective fronts and rears are opposite.

As shown in FIG. 11, in an image forming apparatus 1100 of this example, source document feed tray 141 also serves as source document cover 122 of reading section 120. As shown in FIG. 12, a source document O set in this source document feed tray 141 is ejected and placed onto source document ejection tray 145 positioned above source document feed tray 141. That is to say, as shown in FIG. 11, a source document O is set on source document ejection tray 145 so that the source document surface (image surface) is downward. A source document O set on source document ejection tray 145 is fed toward scanner 143 by source document feed rollers 142, and image information is read by scanner 143. Then source document O whose image information has been read is ejected and placed onto source document ejection tray 145 by source document ejection rollers 144 as shown in FIG. 12.

By this means, as shown in FIG. 12, only sheet ejection tray 151 is present between an ejected source document O and printed sheet Ps. Therefore, with this image forming apparatus 1100, the distance between an ejected source document O and printed sheet Ps is smaller, making it easier for a user to perform the task of simultaneously grasping a source document O and printed sheet Ps with one hand.

Also, with this image forming apparatus 1100, as shown in FIG. 12, a source document O whose image information has been read is ejected and placed onto source document ejection tray 145 so that the source document surface is facing upward, while, in FIG. 12, a printed sheet Ps is ejected and placed onto sheet ejection tray 151 so that its image formation surface is facing downward.

Thus, with this image forming apparatus 1100, ejection and placement are performed so that the source document surface of a source document O and the image formation surface of a printed sheet Ps face each other, so that even if these are removed and stacked together by mistake, source document O and printed sheet Ps can be differentiated extremely easily.

Other configuration elements and operations in image forming apparatus 1100 of this example are similar to configuration elements and operations of image forming apparatus 600 according to Embodiment 3, and therefore descriptions thereof are omitted here.

### Embodiment 6

Next, an image forming apparatus according to Embodiment 6 of the present invention will be described.

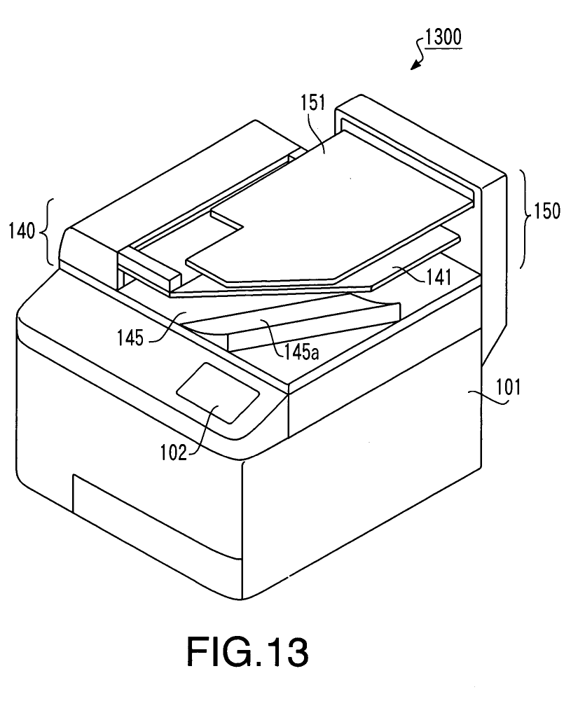

FIG. 13 is a schematic oblique drawing showing an external view of an image forming apparatus according to Embodiment 6 of the present invention.

As shown in FIG. 13, this image forming apparatus 1300 is configured so that the ejection direction of a source document O fed by automatic document feeder 140 and the ejection direction of a printed sheet Ps are twisted through 90 degrees so as to be mutually orthogonal.

Thus, in this image forming apparatus 1300 the lengthwise direction of a source document O ejected and placed onto source document ejection tray 145 after image information has been read and the lengthwise direction of a printed sheet Ps ejected and placed onto sheet ejection tray 151 are mutually orthogonal.

Therefore, with this image forming apparatus 1300, when image forming is performed using automatic document feeder 140, a read source document O and a printed sheet Ps can be simultaneously removed with one hand and differentiated easily.

Other configuration elements and operations in image forming apparatus 1300 of this example are similar to configuration elements and operations of image forming apparatus 700 according to Embodiment 4, and therefore descriptions thereof are omitted here.

With image forming apparatuses 100, 500, 600, 700, 1100, and 1300 according to the embodiments of the present invention, examples have been described in which an electrophotographic method is used as the image forming method of image forming section 130, but it goes without saying that the present invention can also be applied to similar image forming apparatuses that use a different image forming method, such as an ink-jet method.

Also, for image forming apparatuses 100, 500, 600, 700, 1100, and 1300 according to the embodiments of the present invention, multifunctional composite machines have been illustrated that have a copying function, print function, facsimile function, and so forth, but these image forming apparatuses may also have a single function.

As described above, according to the present invention, a source document ejected after image information reading is completed, and a printed sheet on which an image has been formed based on the image information, can be removed easily with one hand while maintaining their segregated state.

The present invention is not limited to the above-described embodiments, and various variations and modifications may be possible without departing from the scope of the present invention.

This application is based on Japanese Patent Application No. 2004-124749 filed on Apr. 20, 2004, the entire content of which is expressly incorporated by reference herein.

1. An image forming apparatus comprising:
a source document feed platform for holding a source document that is fed automatically;
a source document ejection platform for holding a source document fed from said source document feed platform and ejected, positioned below said source document feed platform;
a sheet ejection platform for holding a printed sheet on which an image of said source document has been formed and that is ejected onto an uppermost part of an apparatus main body, positioned above said source document feed platform; and
a source document ejection section that ejects a source document onto said source document ejection platform so that an ejection direction downstream edge of said source document ejected onto said source document ejection platform faces an ejection direction downstream-side position of said source document ejection platform rather than a source document feeding direction upstream edge of said source document feed platform.

2. The image forming apparatus according to claim 1, wherein an ejection direction downstream edge of a printed sheet placed on said sheet ejection platform and an ejection direction downstream edge of a source document placed on said source document ejection platform are ejected so as to be mutually positionally displaced in an ejection direction.

3. The image forming apparatus according to claim 1, wherein said printed sheet placed on said sheet ejection platform and a source document placed on said source document ejection platform are ejected so as to be mutually positionally displaced in a direction orthogonal to an ejection direction.

4. The image forming apparatus according to claim 1, wherein said source document feed platform is displaced upward.

5. The image forming apparatus according to claim 1, wherein:
said source document ejection platform has a curved section that causes an ejection direction downstream edge of a source document ejected onto said source document ejection platform to be curved upward; and
said source document feed platform and said sheet ejection platform are provided with a cutaway section at a position opposite said curved section in a vertical direction.

6. An image forming apparatus comprising:
a source document feed platform for holding a source document;
a source document ejection platform for holding a source document fed from said source document feed platform and ejected, positioned above said source document feed platform; and
a sheet ejection platform for holding a printed sheet on which an image of said source document has been formed and that is ejected onto an uppermost part of an apparatus main body, positioned above said source document feed platform;
wherein a source document placed on said source document ejection platform and said printed sheet placed on said sheet ejection platform are ejected so that their respective front and rear sides are opposite.

7. The image forming apparatus according to claim 6, wherein an ejection direction downstream edge of a printed sheet placed on said sheet ejection platform and an ejection direction downstream edge of a source document placed on said source document ejection platform are ejected so as to be mutually positionally displaced in an ejection direction.

8. The image forming apparatus according to claim 6, wherein an ejection direction downstream edge of said printed sheet placed on said sheet ejection platform and an ejection direction downstream edge of a source document placed on said source document ejection platform are ejected so as to be mutually positionally displaced in an a direction orthogonal to an ejection direction.

9. The image forming apparatus according to claim 6, wherein said source document feed platform is displaced upward.

10. The image forming apparatus according to claim 6, wherein:
said source document ejection platform has a curved section that causes an ejection direction downstream edge of a source document ejected onto said source document ejection platform to be curved upward; and
said source document feed platform and said sheet ejection platform are provided with a cutaway section at a position opposite said curved section in a vertical direction.

11. An automatic document feeder positioned on a top part of a main body of an image forming apparatus provided with an image forming section that performs image forming on a sheet based on source document image information, said automatic document feeder comprising:
a source document feed platform for holding said source document;
a source document feeding section that feeds said source document placed on said source document feed platform;
a source document reading section that reads image information of said source document fed by said source document feeding section;
a source document ejection section that ejects said source document from which said image information has been read by said source document reading section;
a source document ejection platform for holding said source document ejected by said source document ejection section, positioned below said source document feed platform;
a sheet ejection section that transports to above said source document feed platform and ejects a printed sheet on which image forming has been performed by said image forming section; and
a sheet ejection platform for holding said printed sheet ejected by said sheet ejection section, positioned above said source document feed platform;
wherein said source document ejection section ejects a source document onto said source document ejection platform so that an ejection direction downstream edge of said source document ejected onto said source document ejection platform faces an ejection direction downstream-side position of said source document ejection platform rather than a source document feeding direction upstream edge of said source document feed platform.

12. An automatic document feeder positioned on a top part of a main body of an image forming apparatus provided with an image forming section that performs image forming on a sheet based on source document image information, said automatic document feeder comprising:
a source document feed platform for holding said source document;
a source document feeding section that feeds said source document placed on said source document feed platform;
a source document reading section that reads image information of said source document fed by said source document feeding section;
a source document reverse ejection section that takes said source document from which said image information has been read by said source document reading section as a source document and ejects that source document with front and rear sides reversed;
a source document ejection platform for holding said source document ejected by said source document reverse ejection section, positioned above said source document feed platform;
a sheet ejection section that transports to above said source document feed platform and ejects a printed sheet on which image forming has been performed by said image forming section; and
a sheet ejection platform for holding said printed sheet ejected by said sheet ejection section, positioned above said source document feed platform.

13. An image forming apparatus comprising:
a source document feed platform for holding a source document that is fed automatically;
a source document ejection platform for holding a source document fed from said source document feed platform and ejected, positioned below said source document feed platform;
a sheet ejection platform for holding a printed sheet on which an image of said source document has been formed and that is ejected onto an uppermost part of an apparatus main body, positioned above said source document feed platform; and
a source document ejection section that ejects said source document onto said source document ejection platform;
wherein cutaway sections of said source document feed platform and said sheet ejection platform are provided at positions vertically opposite part of a peripheral part of a source document placed on said source document ejection platform.

14. An image forming apparatus comprising:
a source document feed platform for holding a source document that is fed automatically;
a source document ejection platform for holding a source document ejected from said source document feed platform; and
a sheet ejection platform for holding a printed sheet on which an image of said source document has been formed, said source document feed platform, source document ejection platform and sheet ejection platform being provided along a vertical line,
wherein an interval between the source document ejection platform and the sheet ejection platform is set in a dimension that enables a user to use one hand and hold the source document placed in the source document ejection platform and the printed sheet placed in the sheet ejection platform together between fingers of said one hand; and
wherein cutaway sections are provided in mutually vertically opposite areas in the source document ejection platform and the sheet ejection platform to allow entry of the fingers of the user, so as to enable the user to use one hand and hold the source document placed in the source document ejection platform and the printed sheet placed in the sheet ejection platform in a state in which the two documents overlie upon one another in said one hand of the user.

15. The image forming apparatus according to claim 14, wherein at least one of the cutaway sections is made by cutting away a part of the source document ejection platform or the sheet ejection platform.

16. The image forming apparatus of claim 14, wherein at least one of the source document ejection platform and the sheet ejection platform comprises two adjoining planes that form at least one of the cutaway sections.
